(19) United States
(12) Patent Application Publication
(10) Pub. No.: US 2017/0031319 A1
(43) Pub. Date: Feb. 2, 2017

(54) HOLOGRAPHY USING A DOUBLE-END-EMITTING FIBER LASER

(71) Applicant: EMPIRE TECHNOLOGY DEVELOPMENT LLC, Wilmington, DE (US)

(72) Inventor: Nicholas Sheppard Bromer, Marietta, PA (US)

(73) Assignee: EMPIRE TECHNOLOGY DEVELOPMENT LLC, Wilmington, DE (US)

(21) Appl. No.: 15/113,424

(22) PCT Filed: Jan. 22, 2014
(86) PCT No.: PCT/US14/12556

§ 371 Date: Jul. 21, 2016

(51) Int. Cl. G03H 1/04; H01S 3/091; H01S 3/067

(52) U.S. Cl. CPC G03H 1/0465; H01S 3/067; H01S 3/091; G03H 2222/34

(57) ABSTRACT

In some examples, a system may be configured to generate a holographic image of an object. The system may include a holographic recording medium and a fiber laser. The fiber laser may be configured to generate a first output beam at a first end of an optical fiber of the fiber laser. The fiber laser may be further configured to generate a second output beam at a second end of the optical fiber. The first output beam may be configured to be directed toward the object as an illumination beam for the holographic image of the object. Additionally, the second output beam may be configured to be directed toward the holographic recording medium as a reference beam for the holographic image.

### BACKGROUND

Unless otherwise indicated herein, the materials described herein are not prior art to the claims in the present application and are not admitted to be prior art by inclusion in this section.

Holography typically includes the use of at least two laser beams to generate holographic images. Typically, the laser beams are derived from a single laser beam and may be generated and directed from the single laser beam through a series of lenses, mirrors, and beam splitters. The configuration of lenses, mirrors, and beam splitters can be very complex for generating holographic images from different perspectives or for relatively large holographic images.

### SUMMARY

Technologies described herein generally relate to generating holographic images using a laser.

In some examples, a system may be configured to generate a holographic image of an object. The system may include a holographic recording medium and a fiber laser. The fiber laser may be configured to generate a first output beam at a first end of an optical fiber of the fiber laser. The fiber laser may be further configured to generate a second output beam at a second end of the optical fiber. The first output beam may be configured to be directed toward the object as an illumination beam for the holographic image of the object. Additionally, the second output beam may be configured to be directed toward the holographic recording medium as a reference beam for the holographic image.

In some examples, a system configured to generate a holographic image may include a holographic playback medium and a fiber laser. The fiber laser may be configured to generate a first output beam at a first end of an optical fiber of the fiber laser and may be configured to generate a second output beam at a second end of the optical fiber. At least one of the first output beam and the second output beam may be configured to be directed toward the holographic playback medium as a reconstruction beam for playback of a holographic image associated with the holographic playback medium.

In some examples, a method of holography may include generating a first laser beam from a first end of an optical fiber of a fiber laser. The method may further include generating a second laser beam from a second end of the optical fiber. The second laser beam may be substantially in-phase with the first laser beam. The method may also include directing at least a portion of the first laser beam toward a holographic recording medium to generate a reference beam for a holographic image. Additionally, the method may include directing at least a portion of the second laser beam toward an object to generate an illumination beam for the holographic image.

In some examples, a fiber laser may include a pump source configured to generate light and an optical fiber optically coupled to the pump source. The optical fiber may include a first end, a second end, and an optical resonator cavity coupled between the first end and the second end. The optical resonator cavity may be configured to receive and amplify the light generated by the pump source. The optical resonator cavity may also be configured to output a first output portion of the light toward the first end as a first output beam. Further, the optical resonator cavity may be configured to output a second output portion of the light toward the second end as a second output beam.

In some examples, a method of generating a plurality of in-phase laser beams may include generating light with a pump source. The method may further include directing the light into an optical resonator cavity of an optical fiber that includes a resonator first end and a resonator second end. Additionally, the method may include allowing at least a first portion of the light to exit the optical resonator cavity at the resonator first end toward a fiber first end of the optical fiber as a first laser beam. The method may also include allowing at least a second portion of the light to exit the optical resonator cavity at the resonator second end toward a fiber second end of the optical fiber as a second laser beam. The second laser beam may be substantially in-phase with the first laser beam. The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an example fiber laser configured to generate at least two laser beams that are substantially coherent and in-phase with each other;

FIG. 2 illustrates an example fiber laser configured to generate more than two laser beams that are substantially coherent and in-phase with each other;

FIG. 3A illustrates an example system configured to record a holographic image of an object;

FIG. 3B illustrates an example system configured to play back the holographic image of FIG. 3A;

FIG. 4A illustrates an example system configured to record a holographic image of an object;

FIG. 4B illustrates an example system configured to play back the holographic image of FIG. 4A;

FIG. 5 illustrates an example system configured to generate a relatively long, mural-like holographic image;

FIG. 6 illustrates an example system configured to generate a wide-angle holographic image;

FIG. 7 illustrates an example configuration of a system configured to generate a holographic image of an object;

FIG. 8 illustrates a flow diagram of an example method of holography;

FIG. 9 illustrates a flow diagram of an example method of generating multiple in-phase laser beams; and

FIG. 10 is a block diagram illustrating an example computing device that is arranged for generating holographic images;

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Holography may be used to generate three-dimensional images. In some instances, a holographic image or series of holographic images may be generated using laser beams. A beam of light may be directed toward a holographic recording medium and may be referred to as a “reference beam.” Additionally, another beam of light may be directed toward an object and may be referred to as an “illumination beam.” The object may scatter the illumination beam and some of the scattered light from the illumination beam may fall onto the holographic recording medium. The scattered light from the illumination beam may be referred to as an “object beam.” The object beam and the reference beam may intersect and interfere with each other at one or more points of the holographic recording medium to create an interference pattern. The interference pattern may be imprinted on the holographic recording medium and may encode information about the appearance of the object such that a holographic image of the object may be recreated based on the interference.

To play back the holographic image, a laser beam substantially the same as the reference beam or illumination beam—referred to hereinafter as a “reconstruction beam”—is directed toward a holographic playback medium that is encoded with the interference pattern that was imprinted on the holographic recording medium. The reconstruction beam is distorted by the interference pattern of the holographic playback medium in a manner such that the holographic image of the object is generated.

The light used for holography is typically generated by lasers because lasers generate coherent light and holography depends on precise coherency and phase relationships between the reference beam, the illumination beam, the object beam, and the reconstruction beam. Lasers also typically have phase drift where the phase of a laser beam produced by the laser may change or vary. Therefore, the various beams used in holography are typically derived from a single laser beam to maintain the precise phase relationships between the different beams because a change in the phase in the single laser beam may affect the phase of the different beams used in holography in the same manner. In contrast, technologies described herein generally relate to generating holographic images using beams that may be derived from more than one laser beam. The ability to use more than one laser beam from which other beams may be derived in holography may allow for more flexibility in generating holographic images.

In some embodiments, a fiber laser may be configured to generate two or more laser beams that may be substantially coherent and in-phase with each other such that the laser beams may be used together in holography. The fiber laser may include a pump source configured to generate light and an optical fiber optically coupled to the pump source. The optical fiber may include a first end, a second end, and an optical resonator cavity coupled between the first end and the second end. The optical resonator cavity may be configured to receive and amplify the light generated by the pump source. The optical resonator cavity may also be configured to output a first output portion of the light toward the first end of the optical fiber as a first output beam. The optical resonator cavity may also be configured to output a second output portion of the light toward the second end of the optical fiber as a second output beam. As described in detail below, the optical fiber may be configured such that the first output beam and the second output beam may have approximately the same phase, or exactly the same phase, even when the fiber laser experiences phase drift. Accordingly, the first output beam and the second output beam may be used together in holography in some embodiments.

In some embodiments, a system configured to generate a holographic image of an object may include the fiber laser described above and a holographic recording medium. In some embodiments, the first output beam generated by the fiber laser may be configured to be directed toward the object as an illumination beam for the holographic image of the object. In these and other embodiments, the second output beam generated by the fiber laser may be configured to be directed toward the holographic recording medium as a reference beam for the holographic image. In some embodiments, the first output beam and/or the second output beam may be split into two or more portions where one of the portions may be used as an illumination beam and another portion may be used as a reference beam. Additionally, during holographic recording, light diverging from a single fiber can simultaneously shine on or illuminate both the object and the holographic recording medium, and thereby act as both an illumination beam and a reference beam, even if the light from that fiber is not split.

Additionally, in some embodiments, the system configured to generate the holographic image may include a holographic playback medium. The holographic playback medium may be derived from the holographic recording medium in that the holographic playback medium may include the interference recorded by the holographic recording medium. In these or other embodiments at least one of the first output beam and the second output beam may be configured to be directed toward the holographic playback medium as a reconstruction beam for playback of the holographic image of the object.

Reference is now made to the drawings.

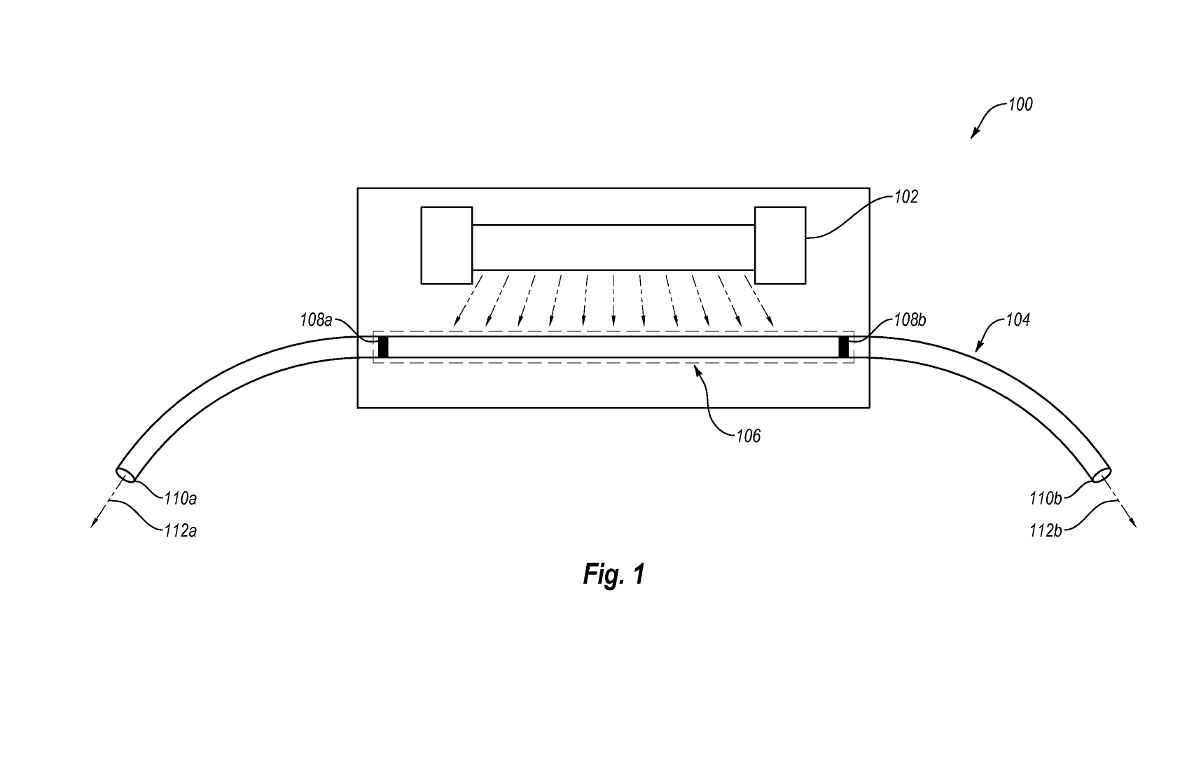

FIG. 1 illustrates an example fiber laser 100 configured to generate at least two laser beams that are substantially coherent and in-phase with each other, arranged in accordance with at least some embodiments described herein. The fiber laser 100 may include a pump source 102 and an optical fiber 104 (referred to hereinafter as the “fiber 104”). The pump source 102 may be any suitable system, device, or apparatus that may generate light (e.g., photons) or light-producing energy. For example, the pump source 102 may include an electrical discharge, a flashlamp, an arc lamp, light from another laser, a chemical reaction, and the like. For example, the pump source may include one or more (such as an array) of light emitting diodes, lasers, or other pump sources.

The fiber 104 may include a portion configured as an optical resonator cavity 106 (referred to hereinafter as “resonator 106”). The resonator 106 may be configured to receive at least a portion of the light and light energy generated by the pump source 102. Additionally, the resonator 106 may include a gain medium configured to amplify the light that is within the resonator 106. For example, the portion of the fiber 104 configured as the resonator 106 may be doped with any suitable element configured to perform optical amplification such as Erbium, Thulium, Praseodymium, or Ytterbium. For example, the resonator portion of the fiber may include a rare-earth doped glass, for example a glass doped with rare earth cations which may be provided by rare earth compounds. In some embodiments, the doping compound may be determined based on the desired frequency of the laser beams that may be generated by the fiber laser 100. In some embodiments, the entire fiber 104 may also be doped.

In some embodiments, the resonator 106 and/or the entire fiber 104 may be any suitable optical fiber that may allow the light from the pump source 102 to enter an outer cladding layer of the optical fiber, amplify the light within the fiber, and have a refractive index such that a specific wavelength of the fiber may propagate through the fiber. For example, in some embodiments, the resonator 106 and/or the entire fiber 104 may be a doped double clad fiber with a doped core and an intermediate cladding surrounding the core. The intermediate cladding may help guide light around the core to aid in pumping the light to the core. Conventional fiber-laser fibers and apparatuses may be used.

The resonator 106 may also include a partial-reflector 108a and a partial-reflector 108b. The partial-reflectors 108 may be disposed at opposite ends of the resonator 106 such that the portion of the fiber 104 between the partial-reflectors 108 may be within the resonator 106 and the portions of the fiber 104 that are not between the partial-reflectors 108 may be outside of the resonator 106.

The partial-reflector 108a may be configured to receive light propagating within the resonator 106 and may reflect a portion of the light back into the resonator 106 toward the partial-reflector 108b. The partial-reflector 108a may also be configured to allow a portion of the light to pass through it such that the partial-reflector 108a may output a portion of the light toward a first end 110a of the fiber 104. The light received at the first end 110a may be output as a first laser beam 112a.

Similarly, the partial-reflector 108b may be configured to receive light propagating within the resonator 106 and may reflect a portion of the light back into the resonator 106 toward the partial-reflector 108a. The partial-reflector 108b may also be configured to allow a portion of the light to pass through it such that the partial-reflector 108b may output a portion of the light toward a second end 110b of the fiber 104. The light received at the second end 110b may be output as a second laser beam 112b. As the light within the resonator 106 is reflected between the partial-reflectors 108, the gain medium may increase the intensity of the light such that the first and second laser beams 112a and 112b may increase in intensity during a charge period of the fiber laser 100.

In some embodiments, the partial-reflectors 108a and 108b may be configured to have approximately the same, or the same, reflectivity such that substantially the same amount of light may pass through the partial-reflectors 108a and 108b. In these or other embodiments, the partial-reflectors 108 may be Bragg grating mirrors, or any other suitable reflector.

The distance between the partial-reflectors 108a and 108b (e.g., the length of the resonator 106) may be set to be smaller than a coherence length of the light within the fiber 104. The coherence length of the light within the fiber 104 may indicate a distance within which the light within the fiber 104 may have the same phase. Accordingly, setting the distance between the partial-reflectors 108a and 108b at smaller than the coherence length may allow for a first phase of the light passing through the partial-reflector 108a toward the first end 110a to be approximately equal to, or exactly equal to, a second phase of the light passing through the partial-reflector 108b toward the second end 110b.

Additionally, a first section of the fiber 104 from the partial-reflector 108a to the first end 110a and a second section of the fiber 104 from the partial-reflector 108b to the second end 110b may be substantially the same in shape, size, and composition such that the first and second sections may affect the phases of the light propagating through them in substantially the same manner. Additionally, the factors that affect phase drift may be substantially the same in the first and second sections. Therefore, the first phase of the light propagating through the first section may be approximately equal to, or equal to, the second phase of the light propagating through the second section at any given distance from the resonator, such that the first laser beam 112a and the second laser beam 112b may be substantially coherent and in-phase with each other. In other words, the phase at some arbitrary distance x (along the first fiber) from partial-reflector 108a may be the same as, or nearly the same as, the phase at the same distance x (along the second fiber) from partial-reflector 108b.

In some embodiments, the coherence length of the light within the fiber 104 may be less than the distance that may be traveled by the light before exiting the ends 110 after passing through the partial-reflectors 108. Accordingly, in these and other embodiments, a first length of the first section of the fiber 104 and a second length of the second section of the fiber 104 may be approximately the same. With the first length and the second length being approximately the same, the laser beams 112a and 112b may be substantially coherent and in-phase with each other (e.g., the phase may be the same at the first end 110a and the second end 110b) even though they may not be in-phase with the light exiting the resonator 106. When the coherence length of the light is greater than the first and second lengths, the first and second lengths may not necessarily be the same but the laser beams 112a and 112b may still be substantially coherent and in-phase with each other.

Accordingly, the fiber laser 100 may be configured to generate two separate laser beams (e.g., first and second laser beams 112a and 112b) that are substantially coherent and in-phase with each other, and that can be freely moved about in space. As described in further detail below, a fiber laser configured such as the fiber laser 100 may be used for generating and/or playing back holographic images. In some embodiments, a fiber laser may be configured to generate more than two laser beams that are substantially coherent and in-phase with each other.

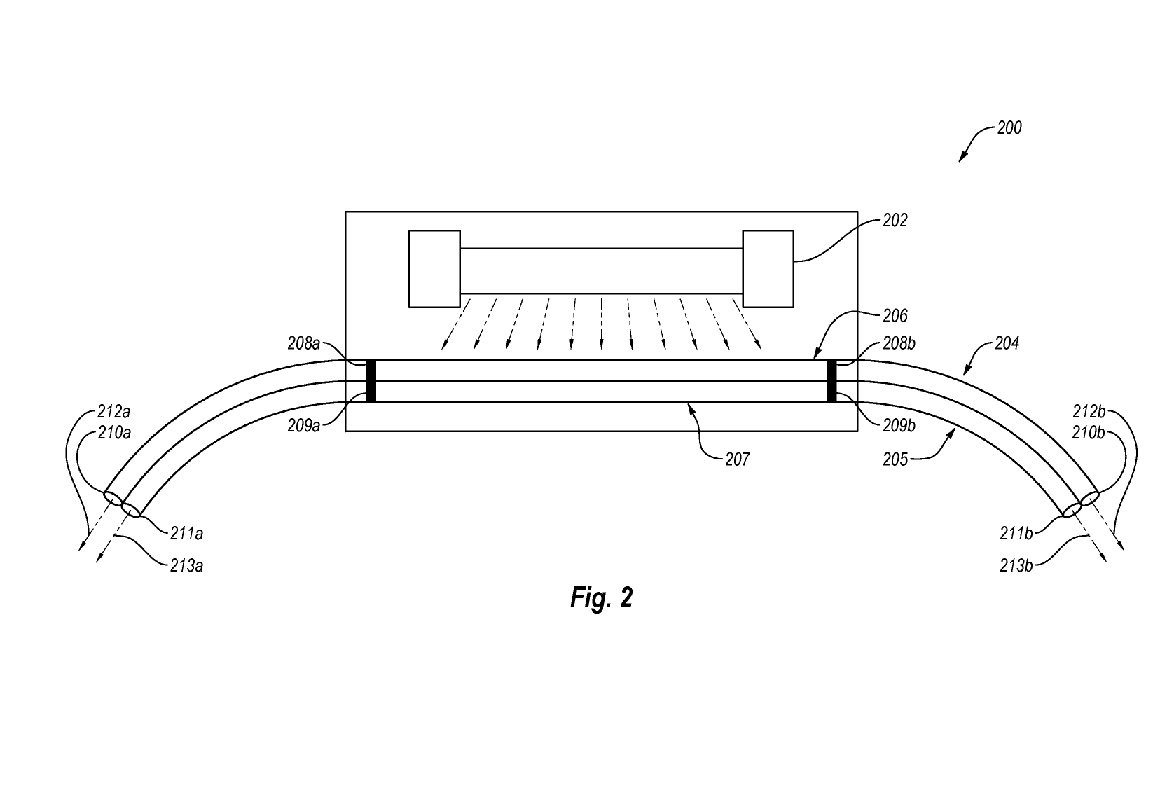

FIG. 2 illustrates an example fiber laser 200 configured to generate more than two laser beams that are substantially coherent and in-phase with each other, arranged in accordance with at least some embodiments described herein. The fiber laser 200 may include a charge pump 202 that may be analogous to the pump source 102 of FIG. 1. Additionally, the fiber laser 200 may include an optical fiber 204 (referred to hereinafter as the “fiber 204”) that may include an optical resonator cavity 206 (referred to hereinafter as the “resonator 206”) and partial-reflectors 208a and 208b. The fiber 204, the resonator 206, and the partial-reflectors 208a and 208b may be analogous to the fiber 104, the resonator 106, and the partial-reflectors 108a and 108b, respectively, of FIG. 1. Accordingly, the fiber 204 may output a first-fiber first laser beam 212a at a first end 210a of the fiber 204 and may output a first-fiber second laser beam 212b at a second end 210b of the fiber 204 analogously to the fiber 104 outputting the first laser beam 112a at the first end 110a and outputting the second laser beam 112b at the second end 110b as described with respect to FIG. 1.

The fiber laser 200 may also include an optical fiber 205 (referred to hereinafter as the “fiber 205”) that may include an optical resonator cavity 207 (referred to hereinafter as the “resonator 207”) and partial-reflectors 209a and 209b. The fiber 205, the resonator 207, and the partial-reflectors 209a and 209b may be analogous to the fiber 204, the resonator 206, and the partial-reflectors 208a and 208b.

The resonator 207 may be optically coupled to the resonator 206 such that light (e.g., photons) that may escape out of the resonator 206 via the outer cladding of the resonator 206 may enter the resonator 207. For example, the resonator 206 and the resonator 207 may be arranged substantially adjacent to each other such that light (e.g., photons) that may escape the resonator 206 may enter the resonator 207 by quantum tunneling through the fiber cladding, or other mechanisms. When two resonators are coupled by mutual photon leakage, they tend to have the same phase. In some embodiments, the resonators 206 and 207 may be touching to help accomplish the optical coupling. Also, the resonators 206 and 207 may be immersed or embedded in a material with an index of refraction suitable for preventing or decreasing internal reflection of photons from the inside of the cladding surface. Further, in some embodiments, the resonators may have their cladding reduced in thickness by abrasion or chemical treatment, to promote tunneling between them. Any method or apparatus that promotes mode-locking between two lasers is within the scope of the present disclosure.

The resonator 207 may amplify and reflect the light via its gain medium and the partial-reflectors 209a and 209b. Additionally, the partial-reflector 209a may be configured to allow a portion of the light within the resonator 207 to pass through it such that the partial-reflector 209a may output a portion of the light toward a first end 211a of the fiber 205. The light received at the first end 211a may be output as a second-fiber first laser beam 213a. The partial-reflector 209b may also be configured to allow a portion of the light within the resonator 207 to pass through it such that the partial-reflector 209b may output a portion of the light toward a second end 211b of the fiber 205. The light received at the second end 211b may be output as a second-fiber second laser beam 213b. Because the fiber 204 and its associated components may be analogous to the fiber 205 and its associated components, the laser beams 212a, 212b, 213a, and 213b may be substantially coherent and in-phase with one another. In some embodiments, the coherence length of the light within the fibers 204 and 205 may be less than the distance that may be traveled by the light before exiting the ends 210 and 211. Accordingly, in these and other embodiments, the lengths of the fibers 204 and 205 from the partial-reflectors 208 and 209, respectively, to the ends 210 and 211, respectively, may be approximately the same or exactly the same. As such, the laser beams 212a, 212b, 213a, and 213b may be substantially coherent and in-phase with each other even though they may not be in-phase with the light exiting the resonators 206 and 207. When the coherence length of the light is greater than the lengths of the fibers 204 and 205 from the partial-reflectors 208 and 209 to the ends 210 and 211, the lengths of the fibers 204 and 205 from the partial-reflectors 208 and 209 to the ends 210 and 211 may not necessarily be the same and the laser beams 212a, 212b, 213a, and 213b may still be substantially coherent and in-phase with each other.

Accordingly, the fiber laser 200 may be configured to generate four separate laser beams (e.g., laser beams 212a, 212b, 213a, and 213b) that are substantially coherent and in-phase with each other. Modifications may be made to the fiber laser 200 without departing from the scope of the present disclosure. For example, more fibers may be added to the fiber laser 200 such that more than four laser beams that are substantially coherent and in-phase with each other may be generated. Additionally, as described in further detail below, a fiber laser configured such as the fiber laser 200 may be used for generating holographic images.

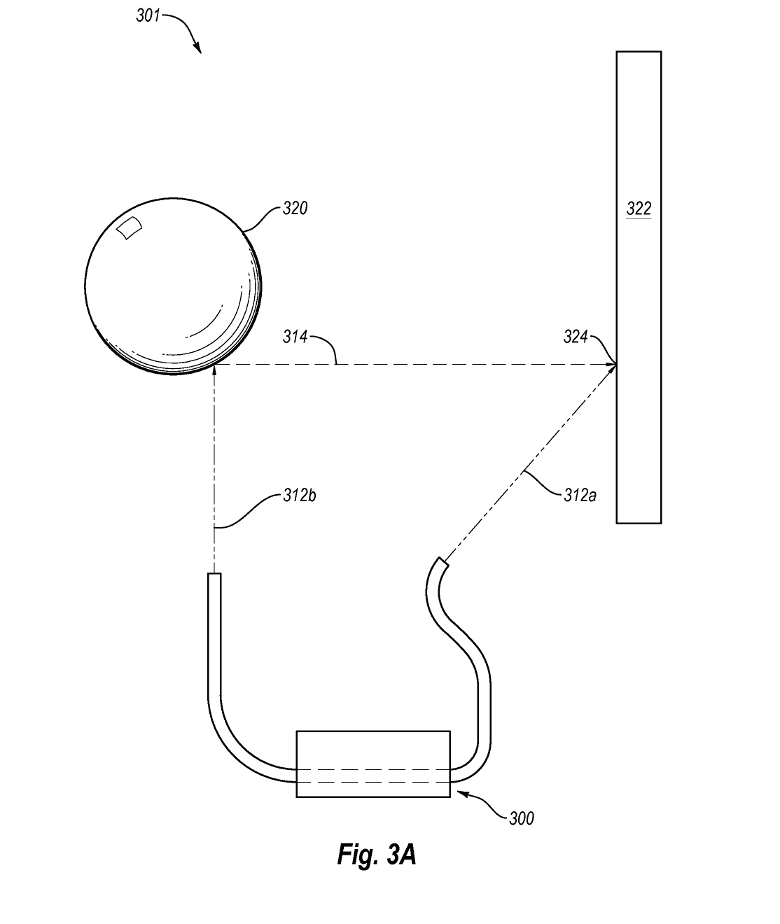

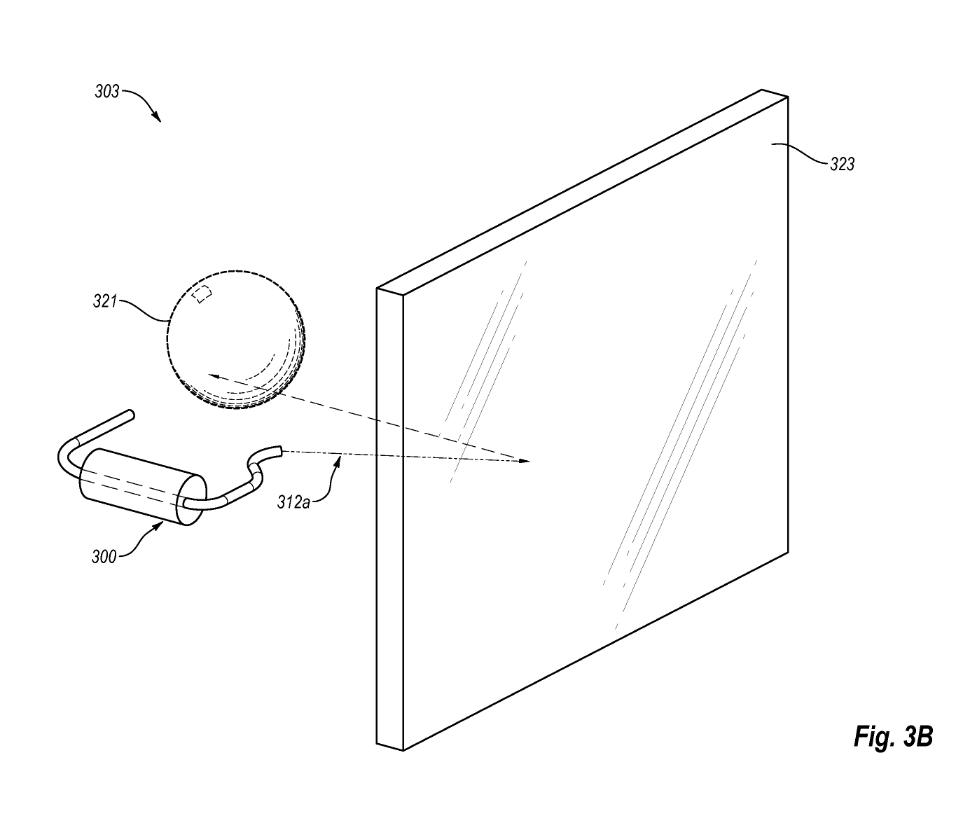

FIG. 3A illustrates an example system 301 configured to record a holographic image of an object 320, arranged in accordance with at least some embodiments described herein. The system 301 may include a fiber laser 300 and a holographic recording medium 322. The fiber laser 300 may be analogous to the fiber laser 100 of FIG. 1 and may be configured to generate a first laser beam 312a and a second laser beam 312b, which may be substantially coherent and in-phase with each other.

In the illustrated embodiment, the first laser beam 312a may be directed toward the holographic recording medium 322 such that the first laser beam 312a may be configured as a reference beam for generating the holographic image of the object 320. The second laser beam 312b may be directed toward the object 320 such that the second laser beam 312b may be configured as an illumination beam for the holographic image of the object 320. Because the first laser beam 312a and the second laser beam 312b may be substantially coherent and in-phase with each other, one may be used as the reference beam and the other may be used as the illumination beam. In contrast, in a conventional holographic system, a single laser beam may be split into the reference beam and the illumination beam. It is understood that, although FIG. 3A indicates a single ray (beam) leaving each of the fibers in an axial direction (as indicated by dot-dash lines), light leaving the tip of an optical fiber may spread angularly due to diffraction. Thus, not only the indicated rays, but also other rays not specifically indicated in FIG. 3A by dot-dash lines, will impinge off the object 320 and also on the medium 322. It is also understood that rays 312b might impinge directly on the object 320 without any intermediate reflection, and that rays 312a might impinge directly on the medium 322 without any intermediate reflection, without hindering the operation described herein.

The light from the second laser beam 312b may be scattered upon striking the object 320, and may generate an object beam 314 that may strike the holographic recording medium 322 at an intersection point 324 of the holographic recording medium that is also struck by the first laser beam 312a. The object beam 314 and the first laser beam 312a may intersect and interfere with each other at the intersection point 324 to create an interference pattern. The holographic recording medium 322 may record the interference pattern, which may be used to generate a holographic image of the object 320, as indicated above and described in further detail below. In the present disclosure, recordation of an interference pattern may also be referred to as recordation of a holographic image due to the interference pattern being used to generate the holographic image.

As mentioned above, although the laser beams 312a and 312b and the object beam 314 are illustrated as narrow, discrete beams that generate the interference pattern at the intersection point 324, the system 301 may include a diverging lens or diverging mirror (not expressly illustrated in FIG. 3A) configured to receive and diverge the first laser beam 312a such that the first laser beam 312a may be configured to illuminate a much larger portion of the holographic recording medium 322 than what is explicitly depicted, or that might result from fiber-tip diffraction alone. Additionally, the system 301 may include another diverging lens or mirror (not expressly illustrated in FIG. 3) configured to receive and diverge the second laser beam 312b such that the second laser beam 312b may be configured to illuminate a much larger portion of the object 320 than what is explicitly depicted, which may cause the object beam to illuminate a much larger portion of the holographic recording medium 322 than what is explicitly depicted, or that might result from fiber-tip diffraction alone. Accordingly, the first laser beam 312a and the object beam 314 may generate an interference pattern at many points of the holographic recording medium 322, which may be recorded by the holographic recording medium 322.

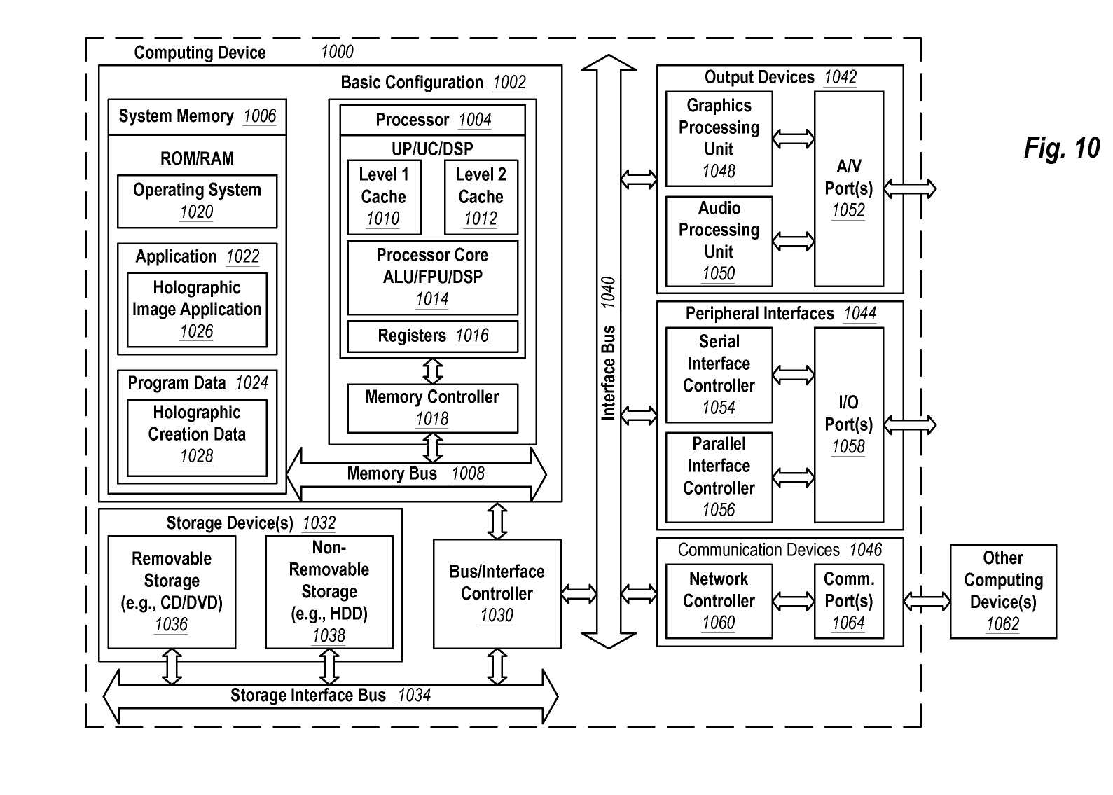

The holographic recording medium 322 may be any suitable system, apparatus, or device configured to record an interference pattern of light that may be generated by a reference beam (e.g., the first laser beam 312a) and an object beam (e.g., the object beam 314) intersecting and interfering with each other at the holographic recording medium 322. For example, the holographic recording medium 322 may be any suitable holographic film that may imprint the interference pattern of the first laser beam 312a and the object beam 314. In other embodiments, the holographic recording medium 322 may be a digital recording medium that may include photo-sensors that may be configured to detect the interference pattern in a manner that the interference pattern may be recorded digitally. In some embodiments, when the interference pattern is digitally recorded, the system 301 may include a computing device, such as a computing device illustrated in FIG. 10, configured to digitally record and/or store the interference pattern.

FIG. 3B illustrates an example system 303 configured to play back a holographic image 321 of the object 320 of FIG. 3A, arranged in accordance with at least some embodiments described herein. The system 303 may include the fiber laser 300 and a holographic playback medium 323.

The fiber laser 300 and the holographic playback medium 323 may be configured to be spaced and oriented with respect to each other in a manner approximately the same as, or the same as, the spacing and orientation of the holographic recording medium 322 and the fiber laser 300 of FIG. 3A. Therefore, the first laser beam 312a of the fiber laser 300 may strike the holographic playback medium 323 in substantially the same manner that the first laser beam 312a may strike the holographic recording medium 322 in FIG. 3A. For example, in some embodiments, the fiber laser 300 may be maintained in the same position as in FIG. 3A and the holographic playback medium 323 may be positioned in the same location and orientation as the holographic recording medium 322.

The holographic playback medium 323 may be configured based on the interference pattern recorded by the holographic recording medium 322. Therefore, when the first laser beam 312a strikes the holographic playback medium 323 of FIG. 3B in substantially the same manner that the first laser beam 312a strikes the holographic recording medium 322 of FIG. 3A, the interference pattern may modify the first laser beam 312a such that the holographic image 321 of the object 320 of FIG. 3A may be generated as illustrated in FIG. 3B. The first laser beam 312a may accordingly be used as the reconstruction beam for the holographic image 321.

In some embodiments, the fiber laser 300 may be configured such that the second laser beam 312b (not expressly illustrated in FIG. 3B) may strike the holographic playback medium 323 in FIG. 3B in substantially the same manner that the first laser beam 312a strikes the holographic recording medium 322 in FIG. 3A such that the second laser beam 312b may act as the reconstruction beam instead of, or in addition to, the first laser beam 312a. The first and second laser beams 312a and 312b may be used interchangeably or simultaneously as the reconstruction beam since they are substantially coherent and in-phase with each other.

The holographic playback medium 323 may be any suitable system, apparatus, or device configured to reproduce the interference pattern that may be recorded by the holographic recording medium 322 of FIG. 3A such that the reconstruction beam may be modified according to the interference pattern to generate the holographic image 321. Therefore, the holographic playback medium 323 may be any suitable spatial light monitor (SLM) that may modulate the reconstruction beam according to the interference pattern recorded by the holographic recording medium 322.

For example, when the holographic recording medium 322 is holographic film, the holographic playback medium 323 may be the holographic film after it has been developed. In other embodiments, such as when the holographic recording medium 322 is a digital recording medium, the holographic playback medium 323 may be a mask printed with the interference pattern. Additionally, in some embodiments, the holographic playback medium 323 may be an LCD display, or similar device, configured to generate the interference pattern. In some embodiments, when the interference pattern is digitally recorded, the system 303 may include a computing device, such as the computing device of FIG. 10, configured to store the interference pattern and reproduce the interference pattern on the holographic playback medium 323 in any suitable manner.

Accordingly, the system 301 may be configured to record an interference pattern that may be used to generate the holographic image 321 of the object 320 where the first laser beam 312a may be used as the reference beam and the second laser beam 312b may be used as the illumination beam. Additionally, the system 303 may be configured to play back the holographic image 321 based on the interference pattern recorded by the system 301.

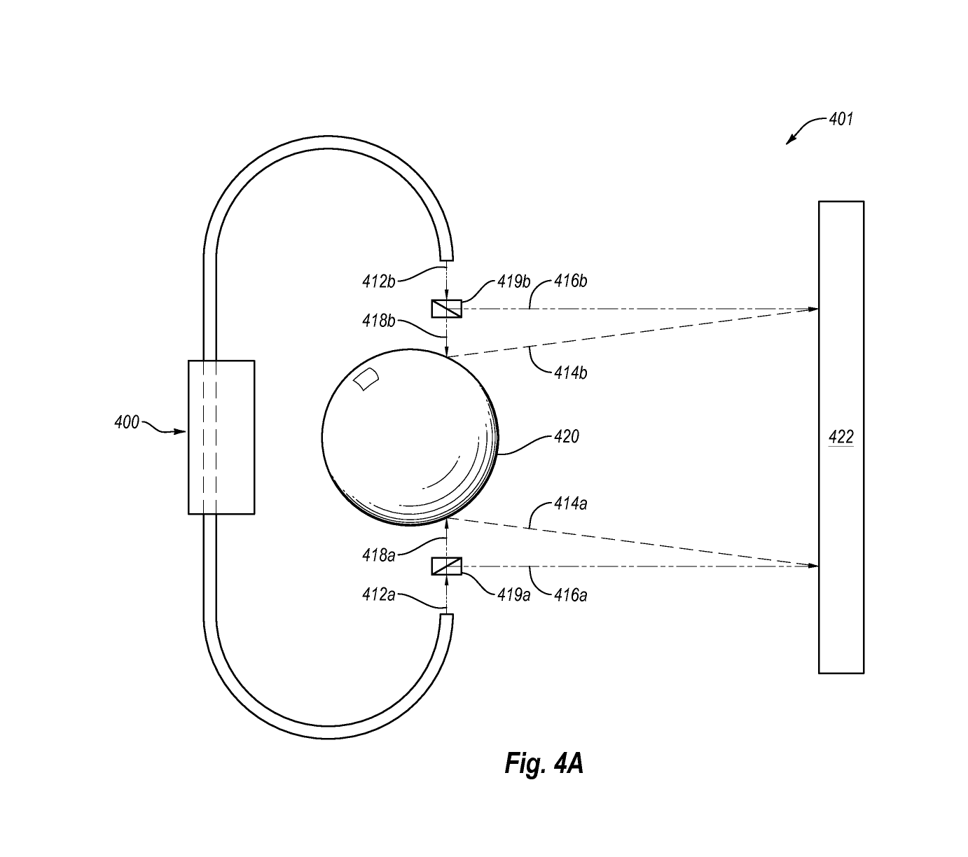

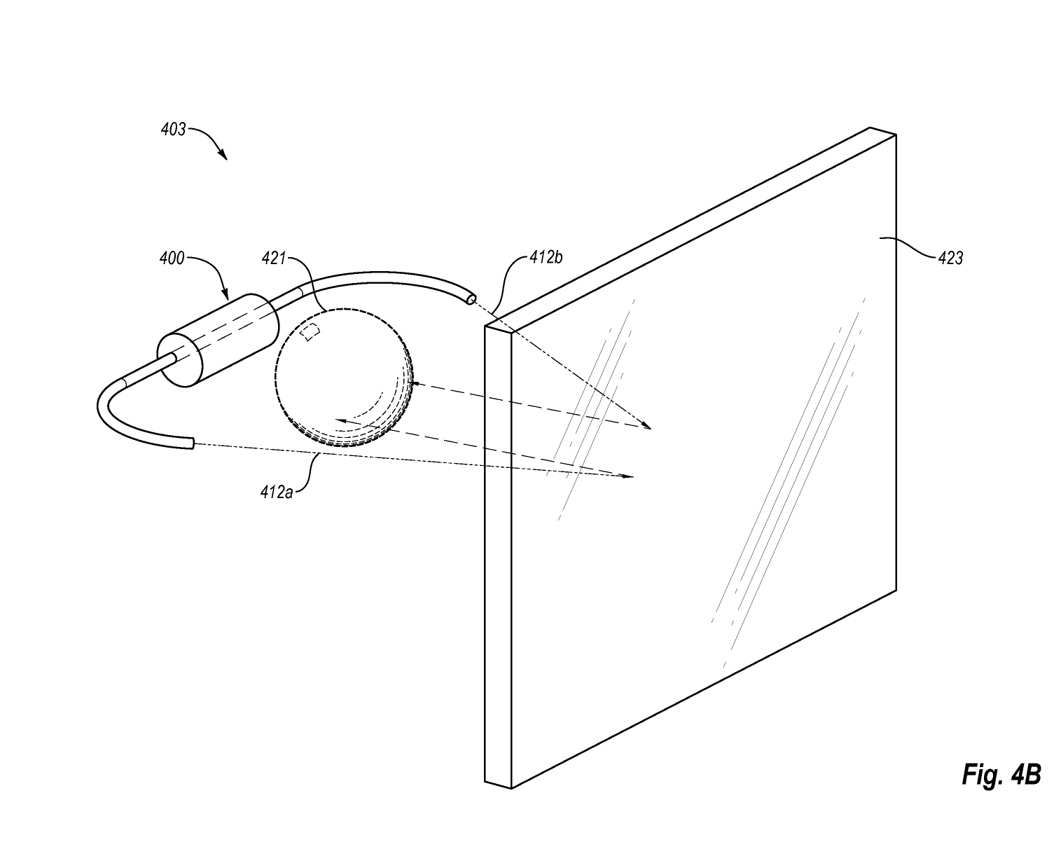

Modifications may be made to the systems 301 and/or 303 without departing from the scope of the present disclosure. For example, in some embodiments, the object 320 may be moving and the system 301 may be configured to record interference patterns associated with a series of holographic images during movement of the object 320. The system 303 may then be configured to play back the series of holographic images in a sequential order. Therefore, in some embodiments, a holographic video may be generated from the series of holographic images. Further, the system 303 may include a diverging lens configured to receive the first laser beam 312a and spread it out such that the first laser beam 312a may strike a substantially larger portion of the holographic playback medium 323 than that expressly illustrated. Additionally, in some embodiments, first and second laser beams (e.g., the first laser beam 312a and the second laser beam 312b) of a fiber laser (e.g., the fiber laser 300) may each be used to generate a reference beam, an illumination beam, and a reconstruction beam, as described with respect to FIGS. 4A and 4B. In some embodiments, especially where the medium 322 is illuminated primarily by the beam(s) 312a, light emission of the beam(s) 312b during playback of a holographic image might be unnecessary.

FIG. 4A illustrates an example system 401 configured to record a holographic image of an object 420, arranged in accordance with at least some embodiments described herein. The system 401 may include a fiber laser 400 and a holographic recording medium 422. The fiber laser 400 may be analogous to the fiber laser 100 of FIG. 1 and may be configured to generate a first laser beam 412a and a second laser beam 412b, which may be substantially coherent and in-phase with each other. Additionally, the holographic recording medium 422 may be analogous to the holographic recording medium 322 of FIG. 3A.

In the illustrated embodiment, the first laser beam 412a may be directed toward a first beam splitter 419a, which may be configured to split the first laser 412a beam into a first first-beam portion 416a and a second first-beam portion 418a. Additionally, the second laser beam 412b may be directed toward a second beam splitter 419b, which may be configured to split the second laser beam 412b into a first second-beam portion 416b and a second second-beam portion 418b.

The first beam splitter 419a may be configured to direct the first first-beam portion 416a toward the holographic recording medium 422 such that the first first-beam portion 416a may be configured as a first reference beam for generating the holographic image of the object 420. The first beam splitter 419a may also be configured to direct the second first-beam portion 418a toward the object 420 such that the second first-beam portion 418a may be configured as a first illumination beam for the holographic image of the object 420.

The second beam splitter 419b may be configured to direct the first second-beam portion 416b toward the holographic recording medium 422 such that the first second-beam portion 416b may be configured as a second reference beam for generating the holographic image of the object 420. The second beam splitter 419b may also be configured to direct the second second-beam portion 418b toward the object 420 such that the second second-beam portion 418b may be configured as a second illumination beam for the holographic image of the object 420.

Because the first laser beam 412a and the second laser beam 412b may be substantially coherent and in-phase with each other, both may be used to generate the holographic image of the object 420 from different points of view of the object 420. In contrast, in a conventional holographic system, a complicated series of lenses, mirrors, and beam splitters may be used to generate the different beams illustrated in FIG. 4A from a single laser beam. It is understood that beam splitters perform a function similar to that performed by diverging lenses and/or mirrors mentioned above, in that they diverge light from one fiber over an angle, whereby it might impinge on several entities such as the object 420 and the medium 422. (However, a diverging lens might not achieve the same angular divergence as a beam splitter.) Diverging lenses, mirrors, beam splitters, and any other devices controlling the angular distribution of light may be chosen and arranged so as to achieve a desired lighting effect in the image during play back, just as non-coherent lighting can be chosen and arranged to achieve a desired lighting effect in conventional photography.

The light from the second first-beam portion 418a may be scattered upon striking the object 420, and may generate an object beam 414a that may strike the holographic recording medium 422. Additionally, the light from the second second-beam portion 418b may be scattered upon striking the object 420, and may generate an object beam 414b that may also strike the holographic recording medium 422. Each of the object beams 414a and 414b may interact with one or more of the first first-beam portion 416a and the first second-beam portion 416b at the holographic recording medium 422 to generate an interference pattern along the holographic recording medium 422. The holographic recording medium 422 may record the interference pattern, which may be used to generate the holographic image of the object 420, as indicated above and described in further detail below. As mentioned above, in the present disclosure, recordation of an interference pattern may also be referred to as recordation of a holographic image due to the interference pattern being used to generate the holographic image.

Although, the first first-beam portion 416a and the first second-beam portion 416b are illustrated as narrow beams that illuminate small portions of the holographic recording medium 422, the system 401 may include one or more diverging lenses (not expressly illustrated in FIG. 4A) configured to receive the first first-beam portion 416a and the first second-beam portion 416b such that the first first-beam portion 416a and the first second-beam portion 416b may be configured to illuminate a much larger portion of the holographic recording medium 422 than what is explicitly depicted. Additionally, the system 401 may include other diverging lenses (not expressly illustrated in FIG. 4A) configured to receive the second first-beam portion 418a and the second second-beam portion 418b such that the second first-beam portion 418a and the second second-beam portion 418b may be configured to illuminate a much larger portion of the object 420 than what is explicitly depicted, which may cause the object beams 414a and 414b to illuminate a much larger portion of the holographic recording medium 422 than what is explicitly depicted. Accordingly, the object beams 414a and 414b and the first first-beam portion 416a and the first second-beam portion 416b may generate the interference pattern along the holographic recording medium 422, even though FIG. 4A does not explicitly illustrate such an occurrence.

FIG. 4B illustrates an example system 403 configured to play back a holographic image 421 of the object 420 of FIG. 4A, arranged in accordance with at least some embodiments described herein. The system 403 may include the fiber laser 400 and a holographic playback medium 423. The holographic playback medium 423 may be analogous to the holographic playback medium 323 of FIG. 3B.

The fiber laser 400 and the holographic playback medium 423 may be configured to be spaced and oriented with respect to each other such that the first laser beam 412a may be configured to strike the holographic playback medium 423 as a first reconstruction beam and such that the second laser beam 412b may be configured to strike the holographic playback medium 423 as a second reconstruction beam. The holographic playback medium 423 may be configured based on the interference pattern recorded by the holographic recording medium 422. Therefore, when the first and second laser beams 412a and 412b strike the holographic playback medium 423 as reconstruction beams, a holographic image 421 of the object 420 of FIG. 4A may be generated by the system 403 of FIG. 4B.

With combined reference to FIGS. 4A and 4B, the system 401 may accordingly be configured to record an interference pattern that may be used to generate the holographic image 421 of the object 420 and the system 403 may be configured to play back the holographic image 421 based on the interference pattern recorded by the system 401. Modifications may be made to the systems 401 and/or 403 without departing from the scope of the present disclosure. For example, in some embodiments, the object 420 may be moving and the system 401 may be configured to record interference patterns associated with a series of holographic images during movement of the object 420. The system 403 may then be configured to play back the series of holographic images in a sequential order. Therefore, in some embodiments, a holographic video may be generated from the series of holographic images.

Further, the system 403 may include one or more lenses, such as diverging lenses, configured to receive the first laser beam 412a and/or the second laser beam 412b and spread them out such that the first laser beam 412a and/or the second laser beam 412b may strike a substantially larger portion of the holographic playback medium 423 than that expressly illustrated. Additionally, in some embodiments, the fiber laser 400 may be replaced with a fiber laser configured to generate four or more laser beams that are substantially coherent and in-phase with each other (e.g., the fiber laser 200 of FIG. 2). In these or other embodiments, the beam splitters may be omitted while also generating reference, illumination, and object beams as illustrated in FIG. 4A. Additionally, in some embodiments, when the interference pattern is digitally recorded, the systems 401 and/or 403 may include a computing device, such as the computing device of FIG. 10, configured to record, store, and/or reproduce the interference pattern on the holographic playback medium 423 in any suitable manner.

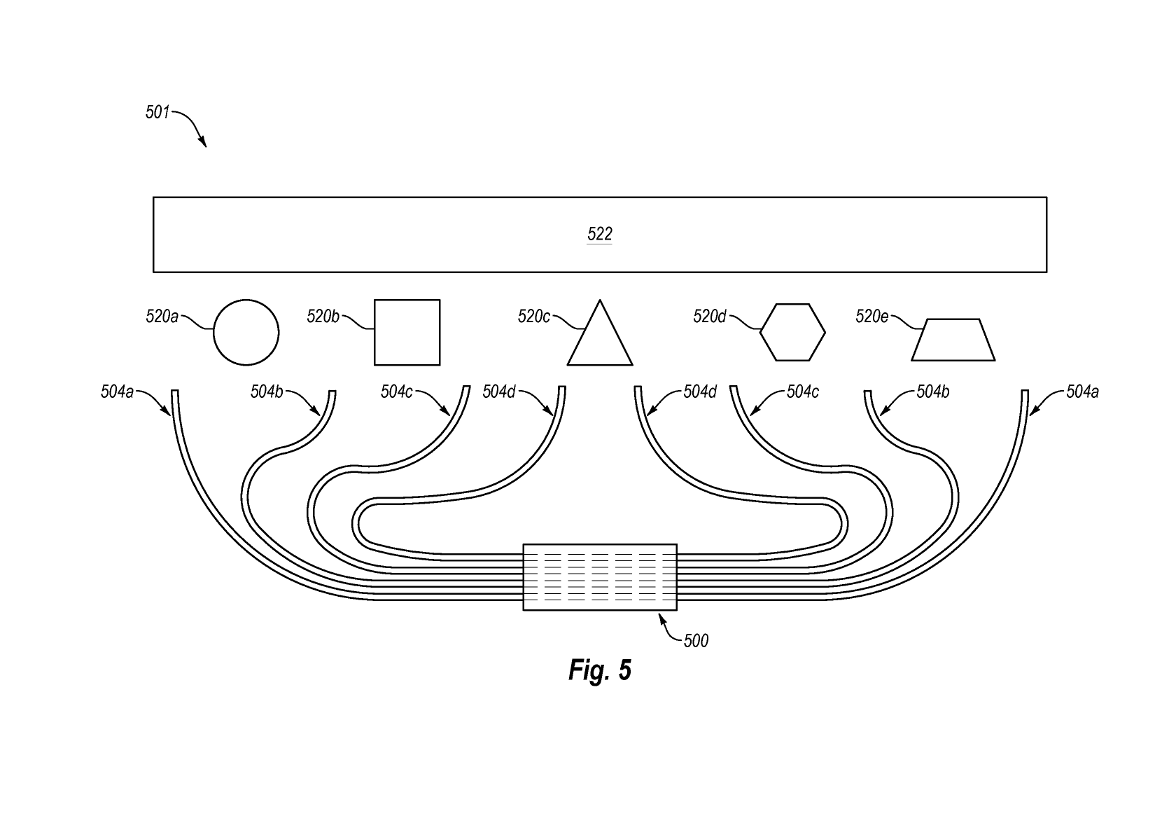

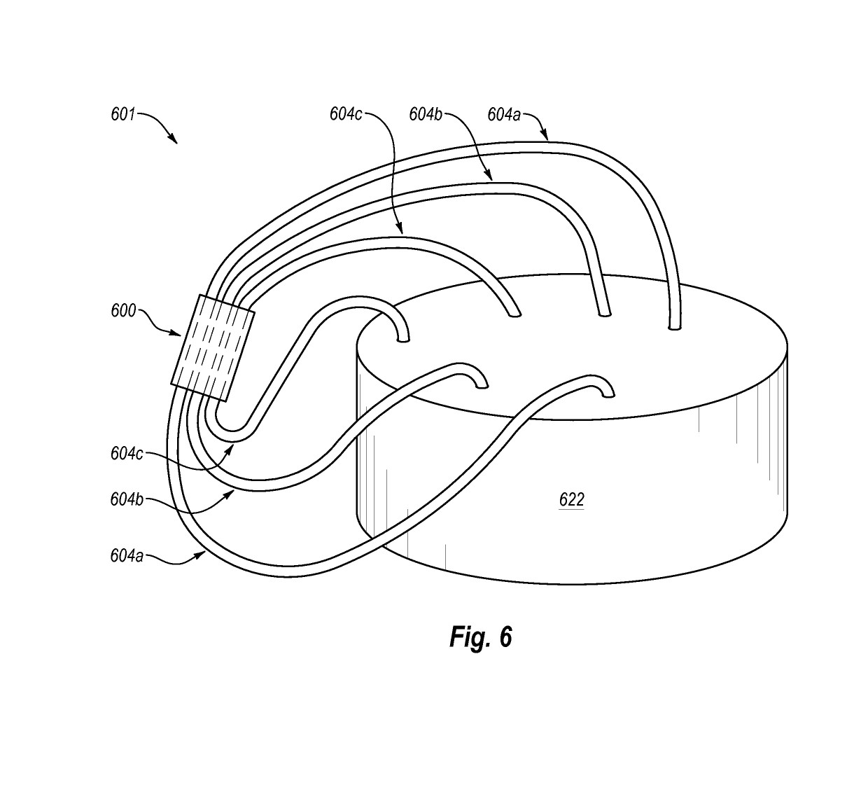

In some embodiments, a fiber laser configured to generate multiple laser beams that are substantially coherent and in-phase with each other may be used to generate relatively large holograms, as described with respect to FIGS. 5 and 6.

FIG. 5 illustrates an example system 501 configured to generate a relatively long, mural-like holographic image, arranged in accordance with at least some embodiments described herein. In the illustrated embodiment, the system 501 may include a holographic recording medium 522. The holographic recording medium 522 may be substantially long such that a holographic image that may be recorded by the holographic recording medium 522 may have a mural-like appearance or dimensions.

The system 501 may also include a fiber laser 500 that includes optical fibers 504a-504d (referred to hereinafter as “fibers 504a-504d”). The fibers 504a-504d may each be configured to output laser beams at opposite ends of each of the fibers 504a-504d. Additionally, the fibers 504a-504d may be configured in a manner analogous to the fibers 204 and 205 of the fiber laser 200 described with respect to FIG. 2 such that the laser beams output at the opposite ends of each of the fibers 504a-504d may be substantially coherent and in-phase with each other. For example, the fibers may be arranged so that their respective resonator portions are optically coupled to each other. In some examples, the resonator portions are configured so that each resonator portion is adjacent the resonator portion of one or more other fibers. In some examples, the resonator portions may be arranged in a bundle. In some examples, the resonator portions may be arranged as a ribbon configuration (one-dimensional array), two-dimensional array, or other configuration of adjacent resonator portions, such as described above.

The ends of the fibers 504a-504d may be configured to be distributed and spaced along a length of the holographic recording medium 522. The laser beams output at the ends of the fibers 504a-504d may be configured to generate reference beams and/or illumination beams (not expressly illustrated in FIG. 5) with respect to one or more of objects 520a-520d. Accordingly, the laser beams output at the ends of the fibers 504a-504d may be configured to generate an interference pattern associated with the objects 520a-520d, which may be recorded by the holographic recording medium 522.

Accordingly, the fiber laser 500 may allow for distribution of substantially coherent and in-phase laser beams along the holographic recording medium 522, which may be relatively long, such that information associated with a mural-like holographic image may be generated. Modifications may be made to the system 501 without departing from the scope of the present disclosure. For example, the number of fibers 504 may vary depending on specific implementations. Additionally, the objects 520 are merely given as examples and may be any number of objects, of any applicable shape and/or size. Further, the shape and size of the holographic recording medium 522 may vary.

Also, in some embodiments, the system 501 may be modified to play back the holographic image recorded on the holographic recording medium 522. For example, the holographic recording medium 522 may be replaced with any suitable holographic playback medium. In these or other embodiments, one or more of the lasers output by the fibers 504 may be used as reconstruction beams to generate the holographic image.

FIG. 6 illustrates an example system 601 configured to generate a wide-angle holographic image, arranged in accordance with at least some embodiments described herein. In the illustrated embodiment, the system 601 is configured to generate a wide-angle holographic image in a 360 degree hologram arrangement. However, other wide-angle holographic images with different degree arrangements (e.g., a 180 degree arrangement) may also be generated using the principles described herein. The system 601 may include a holographic recording medium 622, which may have a circular or cylindrical shape. The system 601 may also include a fiber laser 600 that includes optical fibers 604a-604c (referred to hereinafter as “fibers 604a-604c”). The fibers 604a-604c may each be configured to output laser beams at opposite ends of each of the fibers 604a-604c. Additionally, the fibers 604a-604c may be configured in a manner analogous to the fibers 204 and 205 of the fiber laser 200 described with respect to FIG. 2 such that the laser beams output at the opposite ends of each of the fibers 604a-604c may be substantially coherent and in-phase with each other.

The ends of the fibers 604a-604c may be configured to be distributed and spaced around the holographic recording medium 622, such as in a manner illustrated in FIG. 6. Additionally, one or more objects (not expressly depicted in FIG. 6) may be distributed within the area surrounded by holographic recording medium 622. The laser beams output at the ends of the fibers 604a-604c may be configured to generate reference beams and/or illumination beams (not expressly illustrated in FIG. 6) with respect to one or more of the objects distributed within the area surrounded by the holographic recording medium 622. Accordingly, the laser beams output at the ends of the fibers 604a-604c may be configured to generate an interference pattern associated with the objects, which may be recorded by the holographic recording medium 622.

Accordingly, the fiber laser 600 may allow for distribution of substantially coherent and in-phase laser beams around the holographic recording medium 622, which may be circular or cylindrical in shape, such that information associated with a wide-angle holographic image in a 360 degree arrangement may be recorded. Modifications may be made to the system 601 without departing from the scope of the present disclosure. For example, the number of fibers 604 may vary depending on specific implementations. Additionally, the shape and size of the holographic recording medium 622 may vary.

Also, in some embodiments, the system 601 may be modified to play back the holographic image recorded on the holographic recording medium 622. For example, the holographic recording medium 622 may be replaced with any suitable holographic playback medium. In these or other embodiments, one or more of the laser beams output by the fibers 604 may be used as reconstruction beams to generate the holographic image.

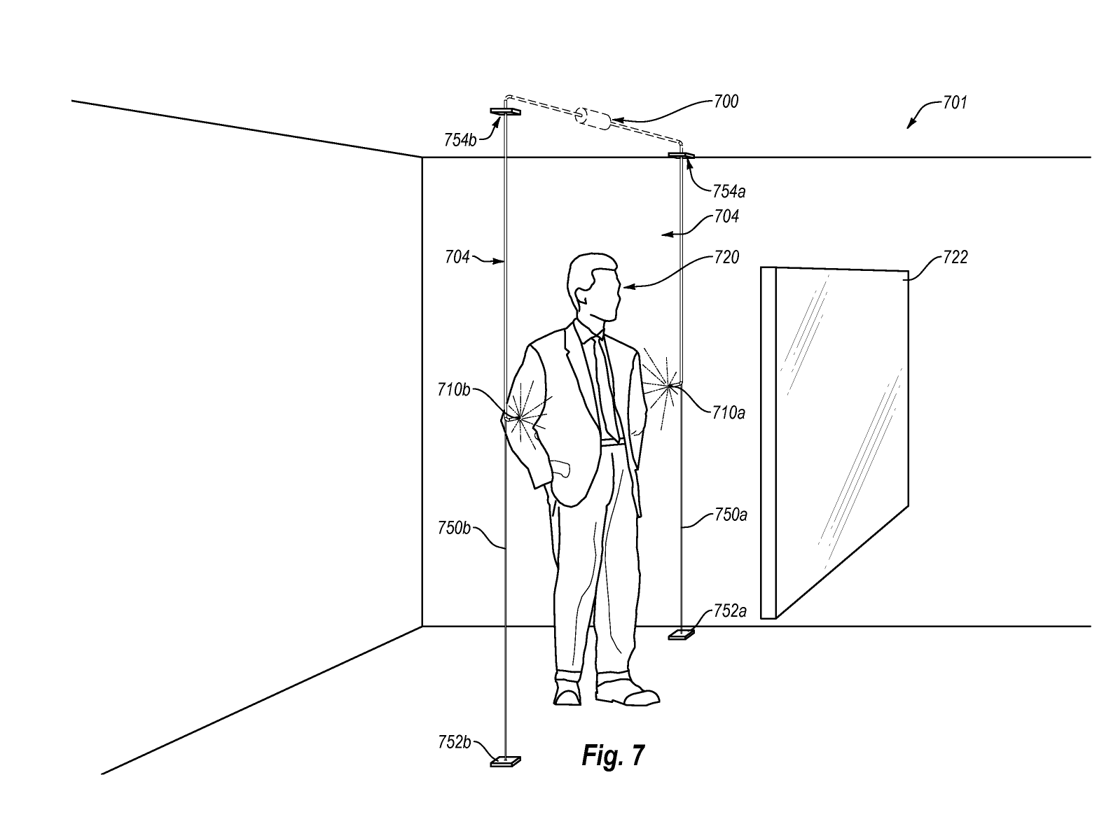

The use of fiber lasers configured to generate more than one coherent and in-phase laser beam may allow for increased flexibility in setting up and configuring the systems 301, 303, 401, 403, 501, and 601 described above. For example, FIG. 7 illustrates an example configuration of a system 701 configured to generate a holographic image of an object 720, arranged in accordance with at least some embodiments described herein.

The system 701 may include a fiber laser 700 and a holographic recording medium 722. The fiber laser 700 may be analogous to the fiber laser 100 of FIG. 1 and may be configured to generate a first laser beam and a second laser beam, which may be output at a first end 710a and a second end 710b of a fiber 704 of the fiber laser 700. Additionally, the holographic recording medium 722 may be analogous to the holographic recording medium 322 of FIG. 3A.

The fiber laser 700 and the holographic recording medium 722 may be configured to generate and record an interference pattern associated with an object 720 (illustrated as a man in FIG. 7) in any suitable manner as described above. In the illustrated embodiment, the fiber laser 700 may be disposed above the object 720—e.g., disposed on or in a ceiling above the object 720. The fiber 704 may be tethered to the ceiling, or any other appropriate structure or object, at two locations such as locations 754a and 754b. The locations 754a and 754b may be selected such that the first end 710a and the second end 710b of the fiber 704 may be oriented in their desired locations for reconstructing or recording a holographic image. In addition, the first end 710a and/or the second end 710b may by fitted with beam-expanding lenses, mirrors, splitters, or other devices that will spread the light so that it shines in the desired amounts on the object 720 and the medium 722. Such tethered lights may advantageously be used in recording and playback of the mural embodiments of FIGS. 5-6.

The system 701 may also include tethers 750a and 750b, which, in the illustrated embodiment, may be anchored to a surface that is directly below the locations 754a and 754b, respectively. The tether 750a may be configured to couple to the first end 710a such that the first end 710a may be substantially held in its desired location. The tether 750b may be similarly configured to couple to the second end 710b such that the second end 710b may be substantially held in its desired location also. The configuration of the system 701 may allow for precise placement of the first and second ends 710a and 710b at their desired locations to record a holographic image of the object 720.

In some embodiments, the configuration of the system 701 may be used for playback of the holographic image of the object 720. For example, the holographic recording medium 722 and the object 720 may be removed and the holographic recording medium 722 may be replaced by any suitable holographic playback medium that may play back a holographic image of the object 720 upon reception of one or more reconstruction beams—e.g., the first and second laser beams output at the first and second ends 710a and 710b, respectively, as reconstruction beams. Placing the holographic playback medium and the first and second ends 710a and 710b such that they are configured and oriented with respect to each other in approximately the same, or the same, manner as the holographic recording medium 722 and the first and second ends 710a and 710b may allow for playback of the holographic image as described above.

In some instances, recreating the same relationship for playback of the holographic image as recordation of the holographic image may be somewhat difficult such that the holographic image may be somewhat distorted when it is reconstructed during playback. Additionally, in these and other embodiments, the tether 750a, the tether 750b, the first end 710a, and/or the second end 710b may move during playback (e.g., due to air movement), which may also cause distortions (such as for example flickers) in the holographic image when it is reconstructed. In some embodiments, the system 701 may include one or more vibrators configured to vibrate the first end 710a and/or the second end 710b in a controlled manner such that the perception of the distortions by a viewer may be reduced and/or eliminated.

For example, in the illustrated embodiment, the system 701 includes vibrators 752a and 752b configured to vibrate the tethers 750a and 750b, respectively. The vibrator 752a and/or the vibrator 752b may be configured to vibrate such that the first end 710a and/or the second end 710b vibrate at an amplitude at least as large as a wavelength of the first and second laser beams output by the first and second ends 710, respectively, so that the phase dithers throughout the wavelength of the laser beams. Accordingly, the phase situation present during recordation of the holographic image may be recreated at least part of the time. Additionally, the frequency of the vibration may be above that of the persistence of vision such that a viewer may not perceive the vibrations. Therefore, the viewer may see an average of the phase difference that includes the actual phase situation at a frequency that may not be noticeable to the viewer.

As mentioned above, the amplitude of the vibration may be at least as large as the wavelength of the first and second laser beams—e.g., at least 650 nanometers (nm) for a red laser beam. However, the amplitude may also be limited to being less than two centimeters (2 cm). Typically the amplitude may be limited to less than a millimeter (mm).

Additionally, as mentioned above, the frequency of the vibration may be at least as great as the persistence of vision, which may be around twenty hertz (20 Hz) or fifteen hertz (15 Hz). The upper limits of the frequency of the vibration may be limited by the physical capabilities of the vibrators 752 and may be as high as 100 kilohertz (KHz). Typically, the frequency of the vibration may be limited to less than 100 Hz.

The vibrators 752a and 752b may include any suitable system, apparatus, or device that may vibrate the tethers 750a and 750b—and consequently the first and second ends 710a and 710b—at a controlled frequency and amplitude. For example, in some embodiments, the vibrators 752a and 752b may be actuators, such as electromechanical actuators. Additionally, in the illustrated embodiment, the vibrators 752a and 752b are depicted as being coupled to the tethers 750a and 750b, respectively, which are coupled to the first and second ends 710a and 710b, respectively. Accordingly, the vibrators 752a and 752b in the illustrated embodiment may be indirectly coupled to the fiber 704 and the first and second ends 710a and 710b and may indirectly vibrate the first and second ends 710a and 710b by vibrating the tethers 750a and 750b. In these or other embodiments, the vibrators 752a and 752b may be directly coupled to the fiber 704 to vibrate the first and second ends 710a and 710b. For example, in some embodiments, the vibrators 752a and 752b may be coupled to the fiber 704 at the locations 754a and 754b.

Although the vibration of fiber ends is described with respect to the specific configuration FIG. 7, the vibration described above may be used in any suitable configuration. For example, a fiber laser as described in other examples of the present disclosure may be configured to emit a light beam out of each of the first and second ends of the fiber laser, and the first end and/or the second end may be configured to vibrate via one or more vibrators, such as actuators.

Modifications may be made to the system 701 without departing from the scope of the present disclosure. For example, the location and number of components listed are merely for illustrative purposes. Specific configurations of holographic systems that employ the principles described above may not be the same as that illustrated in FIG. 7, but may still be within the scope of the present disclosure.

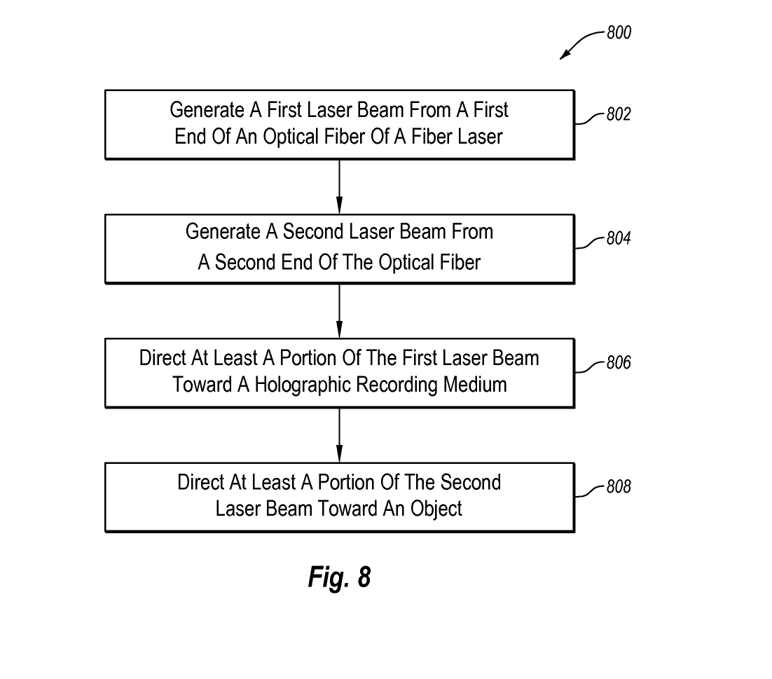

FIG. 8 illustrates a flow diagram of an example method 800 of holography, arranged in accordance with at least some embodiments described herein. The method 800 may be performed in whole or in part by one or more of the systems 301, 303, 401, 403, 501, 601, 701, or any other suitable system or apparatus. The method 800 includes various operations, functions, or actions as illustrated by one or more of blocks 802, 804, 806, and/or 808. The method 800 may begin at block 802.

In block 802 (“Generate A First Laser Beam From A First End Of An Optical Fiber Of A Fiber Laser”), a first laser beam may be generated and output from a first end of an optical fiber of a fiber laser. Block 802 may be followed by block 804.

In block 804 (“Generate A Second Laser Beam From A Second End Of The Optical Fiber”), a second laser beam may be generated and output from a second end of the optical fiber of the fiber laser. In some embodiments, the first and second laser beams may be generated in a manner such as described above with respect to the generation of the first and second laser beams 112a and 112b of FIG. 1. Therefore, the first and second laser beams may be substantially coherent and in-phase with each other. Block 804 may be followed by block 806.

In block 806 (“Direct At Least A Portion Of The First Laser Beam Toward A Holographic Recording Medium”), at least a portion of the first laser beam may be directed toward a holographic recording medium to generate a reference beam for a holographic image. Block 806 may be followed by block 808.

In block 808 (“Direct At Least A Portion Of The Second Laser Beam Toward An Object”), at least a portion of the second laser beam may be directed toward an object to generate an illumination beam for the holographic image. As mentioned above, the illumination beam may scatter off of the object to generate an object beam that may interfere with the reference beam at the holographic recording medium to generate an interference pattern. The holographic recording medium may record the interference pattern such that the holographic image of the object may be recorded by the holographic recording medium.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 800 may include splitting the first laser beam into a first portion and a second portion. The first portion may be directed toward the holographic recording medium to generate the reference beam for a holographic image. Additionally, the second portion may be directed toward the object to generate a second illumination beam for the holographic image.

In these and other embodiments, the method 800 may include splitting the second laser beam into a first portion and a second portion. The first portion of the second laser beam may be directed toward the holographic recording medium to generate a second reference beam for a holographic image. Additionally, the second portion of the second laser beam may be directed toward the object to generate the illumination beam for the holographic image.

Further, the method 800 may include configuring at least one of the first laser beam and the second laser beam to generate a reconstruction beam for a holographic image for playback of the holographic image. In these or other embodiments, the method 800 may include vibrating at least one of the fiber first end and the fiber second end during playback of the holographic image.

Additionally, the method 800 may include generating a plurality of first laser beams and a plurality of second laser beams with a plurality of optical fibers. In these and other embodiments, the method 800 may include generating a mural-like holographic image using the plurality of first laser beams and the plurality of second laser beams. Alternately or additionally, the method 800 may include generating a wide-angle holographic image using the plurality of first laser beams and the plurality of second laser beams. The method 800 may also include including the holographic image in a plurality of holographic images to create a video of holographic images.

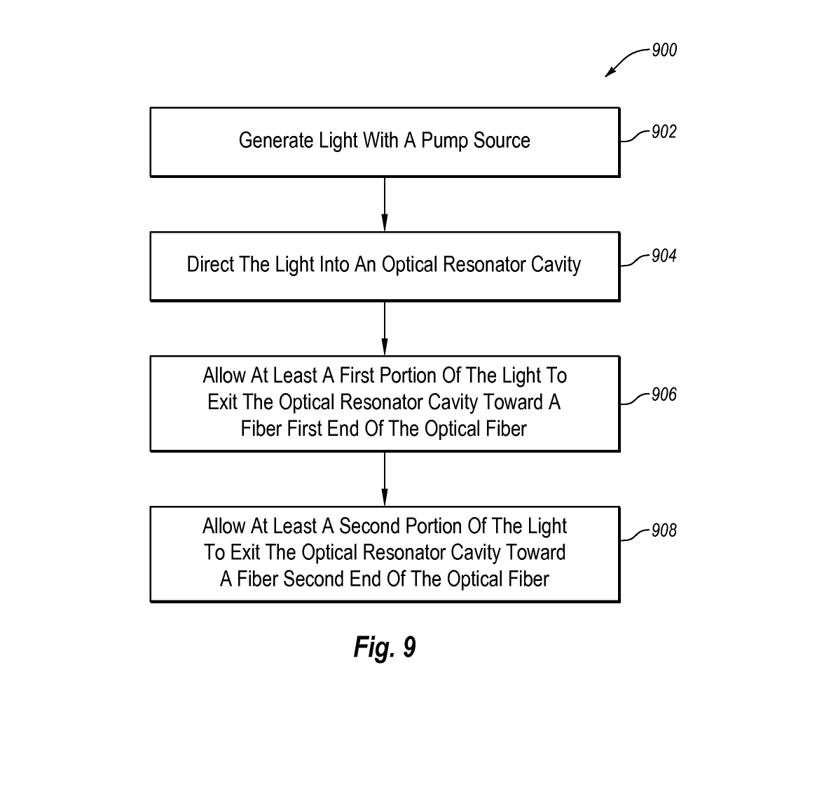

FIG. 9 illustrates a flow diagram of an example method 900 of generating multiple in-phase laser beams, arranged in accordance with at least some embodiments described herein. The method 900 may be performed in whole or in part by one or more of the fiber lasers 100, 200, 300, 400, 500, 600, 700, or any other suitable fiber laser. The method 900 includes various operations, functions, or actions as illustrated by one or more of blocks 902, 904, 906, and/or 908. The method 900 may begin at block 902.

In block 902 (“Generate Light With A Pump Source”), light may be generated by a pump source. Block 902 may be followed by block 904.

In block 904 (“Direct The Light Into An Optical Resonator Cavity”), the light may be directed into an optical resonator cavity of an optical fiber. The optical resonator cavity may include a resonator first end and a resonator second end. Block 904 may be followed by block 906.

In block 906 (“Allow At Least A First Portion Of The Light To Exit The Optical Resonator Cavity Toward A Fiber First End Of The Optical Fiber”), at least a first portion of the light may be allowed to exit the optical resonator cavity at the resonator first end toward a fiber first end of the optical fiber as a first laser beam. Block 906 may be followed by block 908.

In block 908 (“Allow At Least A Second Portion Of The Light To Exit The Optical Resonator Cavity Toward A Fiber Second End Of The Optical Fiber”), at least a second portion of the light may be allowed to exit the optical resonator cavity at the resonator second end toward a fiber first end of the optical fiber as a second laser beam. The fiber and the optical resonator cavity may be configured such that the first and second laser beams may be substantially coherent and in-phase with each other. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 900 may include directing light from the optical resonator cavity into a second optical resonator cavity of a second optical fiber that includes opposite ends. The light may be allowed to exit the second optical resonator cavity toward both of the opposite ends of the fiber such that two or more laser beams may be generated. The second optical fiber and the second optical resonator cavity may be configured similar to the first optical fiber and the first optical resonator cavity such that the two additional laser beams may be substantially coherent and in-phase with the first and second laser beams.

Additionally, the steps illustrated in FIGS. 8-9 can be performed without the use of fiber lasers. For example, a non-fiber laser such as a gas-filled He—Ne laser with discrete mirror end reflectors of equal reflectivity may emit coherent light from each end, and such light can be used to illuminate an object and a medium using conventional mirrors and beam splitters; or, such light can be channeled into respective optical fibers and used for holography as described above. Still further, the output of a single-ended conventional laser could be split and introduced into different fibers of equal length; or the output of a non-fiber double-ended laser could be split into several fibers at each end, and the light in these fibers can be used as described above. There are various structures that will result in multiple sources of coherent light for holography, which can be used with optical fibers for flexible lighting with coherent-phase light for holography.

FIG. 10 is a block diagram illustrating an example computing device 1000 that is arranged for generating holographic images, arranged in accordance with at least some embodiments described herein. In a very basic configuration 1002, the computing device 1000 typically includes one or more processors 1004 and a system memory 1006. A memory bus 1008 may be used for communicating between the processor 1004 and the system memory 1006.

Depending on the desired configuration, the processor 1004 may be of any type including, but not limited to, a microprocessor (μP), a microcontroller (μC), a digital signal processor (DSP), or any combination thereof. The processor 1004 may include one more levels of caching, such as a level one cache 1010 and a level two cache 1012, a processor core 1014, and registers 1016. An example processor core 1014 may include an arithmetic logic unit (ALU), a floating point unit (FPU), a digital signal processing core (DSP Core), or any combination thereof. An example memory controller 1018 may also be used with processor 1004, or in some implementations memory controller 1018 may be an internal part of processor 1004.

Depending on the desired configuration, the system memory 1006 may be of any type including, but not limited to, volatile memory (such as RAM), non-volatile memory (such as ROM, flash memory, etc.), or any combination thereof. The system memory 1006 may include an operating system 1020, one or more applications 1022, and program data 1024. The application 1022 may include a holographic image application 1026 that is arranged to store and/or recreate an interference pattern associated with a holographic image. Program data 1024 may include holographic creation data 1028 that may be useful for recording the interference pattern or recreating the interference pattern on any suitable holographic playback medium, as is described herein. In some embodiments, the application 1022 may be arranged to operate with program data 1024 on operating system 1020 such that holographic images may be generated, recorded, and/or played back. This described basic configuration 1002 is illustrated in FIG. 10 by those components within the inner dashed line.

The computing device 1000 may have additional features or functionality, and additional interfaces to facilitate communications between the basic configuration 1002 and any required devices and interfaces. For example, a bus/interface controller 1030 may be used to facilitate communications between the basic configuration 1002 and one or more data storage devices 1032 via a storage interface bus 1034. Data storage devices 1032 may be removable storage devices 1036, non-removable storage devices 1038, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

System memory 1006, removable storage devices 1036, and non-removable storage devices 1038 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, a digital holographic recording and/or playback medium, or any other medium which may be used to store the desired information and which may be accessed by the computing device 1000. Any such computer storage media may be part of the computing device 1000.

The computing device 1000 may also include an interface bus 1040 for facilitating communication from various interface devices (e.g., output devices 1042, peripheral interfaces 1044, and communication devices 1046) to the basic configuration 1002 via the bus/interface controller 1030. Example output devices 1042 include a graphics processing unit 1048 and an audio processing unit 1050, which may be configured to communicate to various external devices such as a display or speakers via one or more A/V ports 1052. Example peripheral interfaces 1044 include a serial interface controller 1054 or a parallel interface controller 1056, which may be configured to communicate with external devices such as input devices (e.g., keyboard, mouse, pen, voice input device, touch input device, etc.) or other peripheral devices (e.g., printer, scanner, etc.) via one or more I/O ports 1058. An example communication device 1046 includes a network controller 1060, which may be arranged to facilitate communications with one or more other computing devices 1062 over a network communication link via one or more communication ports 1064.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media,” as used herein, may include both storage media and communication media.

The computing device 1000 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 1000 may also be implemented as a personal computer including both laptop computer and non-laptop computer configurations.

In some examples, a double-ended fiber laser is configured so that light emerges substantially in-phase from two ends of the optical fiber in phase. The fiber ends can be placed in any desired location to illuminate the holographed object and the recording medium. A recorded image may then be played back (recreated) using a similar arrangement. Some examples include methods and apparatus configured to capture live scenes, for example by recording a video signal, for example as a sequence of holographic images.

Advantages of some examples may include one or more of the following, such as an increased capture scene range and a reduced size of the holographic recording and/or capturing device. For example, the fiber may be used to guide a light beam to the desired locations without need for a separate optical component, such as a beam splitter. In some examples holography may be performed using two or more optically coupled light sources, allowing an increased image scene width. Image capture may be simplified because the optical fiber tip is small and can be placed easily at any desired point in space. A plurality of optically coupled light sources can increase the size and/or the angular range of viewing a hologram, and the recording medium or recording surface may be extended. For example, as mentioned above, a large (e.g. wide) hologram may be created using a large recording and/or playback medium (e.g., tens of feet long) and a plurality of phase-synchronized light sources. A recording and/or playback surface can be formed in an arbitrary shape, such as curved (e.g. cylindrical) shape. Light sources and/or holographed object(s) may be optionally located inside a curved surface. In some examples, a hologram may be created that can be viewed from any angle, for example using a curved spatial light modulator. Multiple light sources for illuminating the holographic subject may also be used to improve the aesthetics of the holographic image, for example using a plurality of illumination wavelengths (e.g. colors).

Applications include a holographic image recording device (such as a holographic camera and/or video recorder), a holographic image display device (e.g. video displays for television, movies, streaming video, and the like), advertising displays, security apparatus (e.g. an apparatus that captures the three-dimensional profile data for a subject, and compares it to a database of known and/or suspected miscreants), and the like. For example, a holographic image recording device may include one or more double-ended output fiber lasers, each fiber laser configured so that with one end illuminates a recording sensor, and the other end illuminates a subject (when the laser is energized).

In some examples, a fiber laser includes an active medium, such as the active-medium doped core of a resonator region. In some examples, a fiber laser may include a double-clad optical fiber, with a core that provides the lasing resonant cavity and acts as a waveguide, an outer cladding layer and an intermediate cladding layer surrounding the core and located between the core and the outer cladding. The intermediate cladding layer has an intermediate index of refraction (between the core and the outer cladding) and may be used to guide pumping light along the length of the fiber to allow pumping of the core away from the pump light source. The outer cladding helps guide laser and pump light. An intermediate cladding layer is optional, and the core can be pumped using light passing through the outer cladding. In some examples, the active medium may be confined to a resonator portion of the fiber, for example using selective doping. In some examples, an active medium may be introduced as a resonator fiber portion which may be spliced at each end to non-active core fibers.

A laser resonant cavity may comprise a pair of spaced apart fiber Bragg grating reflectors, separated by a fiber portion having active medium core. Bragg gratings may be formed as a periodic variation in the refractive index of the core, for example using a doping profile. The two Bragg grating reflectors may have equal reflectivity, allowing laser light with substantially equal intensity to emerge out of each end of the resonant cavity and propagate in opposite directions, away from the resonant cavity. Light may then be emitted from both ends of the fiber and, in some examples, counter-propagating beams from each fiber end are substantially in phase with each other. Light leaving the two fiber ends may be phase-correlated and be used for holography. In some examples, the reflectivity ratio of the Bragg reflectors may be adjusted to obtain a desired intensity ratio between the two output beams. For example, for distant objects, the illumination beam may have a higher intensity.

The fiber may be a single-mode fiber, and may have a fiber core diameter of, for example, in the range 5-50 microns, such as 8-10 microns. Ranges are non-limiting and may be approximate in some examples. The fiber may have an outer cladding layer, and in some examples may include an intermediate cladding layer. Emerging light may be angularly dispersed using some combination of diffraction, reflection, and/or refraction, for example using one or more lenses and/or mirrors. A digital recording medium may be used to record the holograph (e.g. by recording the intensity profile of interferometric patterns. A digital recording medium may include a sensor array. A spatial light modulator may be used for playback (display) of the hologram. A fiber end may be readily adjusted into a desired position, and a relatively rigid (compared to the fiber) support may be used to reduce stray motion of the fiber. In some examples, a fiber may be tethered to hold the fiber in a desired position.

In some examples, a plurality of fiber lasers may be mode-locked by having their active regions put into close proximity, such as physical contact, or otherwise optically coupled. The active regions of adjacent fibers may be placed in physical contact, for example the active regions being arranged approximately in parallel with the outer cladding layers in contact. In some examples, a coupling medium may be placed between adjacent fibers, such as an optical adhesive, to promote optical coupling. In some examples, a double-core single-mode optical fiber may be used to obtain two mode-locked fibers. Coherent light may be produced from a plurality of light sources, such as a plurality of mode-locked double-ended output fiber lasers. A double-ended fiber laser can be configured to record on a recording medium, and then the same or similar configuration can be used, in some examples elsewhere, for playback.

In some examples, a fiber laser has one or two fiber ends that may be vibrated, for example using one or more actuators, Playback may include vibrating one or both the fiber ends during display. The vibration may have an amplitude at least as large as a light wavelength (e.g. within the range of displayed light wavelengths), and a frequency above that of the persistence of vision, such as above approximately 20 Hz, for example in the range 20 Hz-100 Hz. On vibration, the phase on the playback surface dithers and may be averaged. This may significantly reduce positional accuracy requirements (e.g. for the fiber ends), but may in some examples reduce display intensity.

In some examples, a recording and/or display apparatus may include one or more fibers that may be vibrated, e.g. by an actuator. A tensioned fiber, for example a fiber tethered in position, may be vibrated by a small transducer, for example using an amplitude at least as large as a light wavelength and a frequency above that of the persistence of vision. This may reduce the effects of stray vibration on a display, due to (for example) air-current induced motion or other stray vibrations of the fiber.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A system configured to generate a holographic image of an object, the system comprising:
a holographic recording medium; and
a fiber laser comprising:
a pump source configured to generate light; and
an optical fiber optically coupled to the pump source, wherein the optical fiber includes:
an optical resonator cavity configured to: receive at least a portion of the light generated by the pump source; amplify the light output a first output portion of the amplified light and output a second output portion of the amplified light;
a first end configured to output the first output portion of the amplified light as a first output beam, wherein the first end is directed with respect to the object such that at least a portion of the first output beam strikes the object as an illumination beam for the holographic image of the object;
a first portion that extends from the optical resonator cavity to the first end, wherein the first portion has a first length and is configured to: receive the first output portion of the amplified light from the optical resonator cavity; and direct the first output portion toward the first end such that the first output portion is output at the first end as the first output beam;
a second end configured to output the second output portion of the amplified light as a second output beam, wherein the second end is directed with respect to the holographic recording medium such that at least a portion of the second output beam strikes the holographic recording medium as a reference beam for the holographic image; and
a second portion that extends from the optical resonator cavity to the second end, wherein the second portion has a second length equal to the first length and is configured to: receive the second output portion of the amplified light from the optical resonator cavity; and direct the second output portion toward the second end such that the second output portion is output at the second end as the second output beam.

2. The system of claim 1, wherein at least a portion of the first output beam is configured to be directed toward the holographic recording medium as a second reference beam for the holographic image.

3. The system of claim 2 further comprising a beam splitter configured to receive the first output beam and split the first output beam into the illumination beam and the second reference beam.

4. The system of claim 1, wherein at least a portion of the second output beam is configured to be directed toward the object as a second illumination beam for the holographic image.

5. The system of claim 4 further comprising a beam splitter configured to receive the second output beam and split the second output beam into the reference beam and the second illumination beam.

6. The system of claim 1, further comprising a holographic playback medium, wherein at least one of the first output beam and the second output beam is configured to be directed toward the holographic playback medium as a reconstruction beam for the holographic image for playback of the holographic image.

7. The system of claim 1, further comprising at least one vibrator configured to vibrate at least one of the first end and the second end.

8. The system of claim 7, wherein the at least one vibrator is configured to vibrate at least one of the first end and the second end at an amplitude greater than or equal to a wavelength of the first output beam or the second output beam.

9. The system of claim 8, wherein the at least one vibrator is configured to vibrate at least one of the first end and the second end at an amplitude less than or equal to one millimeter.

10. (canceled)

11. (canceled)

12. The system of claim 1, wherein the fiber laser comprises a plurality of optical fibers, each of the plurality of optical fibers being configured to output a laser beam at opposite ends of each of the plurality of optical fibers, each laser beam being configured to be directed toward at least one of the object and the holographic recording medium to generate a plurality of illumination beams and a plurality of reference beams for the holographic image.

13. The system of claim 12, further comprising a holographic playback medium, wherein at least one of the laser beams is configured to be directed toward the holographic playback medium as a reconstruction beam for the holographic image for playback of the holographic image.

14. The system of claim 12, wherein one or more of the laser beams output by the plurality of optical fibers are configured to generate one or more of: a mural-like holographic image and a wide-angle holographic image.

15.-30. (canceled)

31. The system of claim 1, wherein the optical resonator cavity comprises:
a first partial-reflector coupled between the first end and the second end, the first partial-reflector being configured to output the first output portion of the amplified light toward the first end and configured to reflect a first reflected portion of the light toward the second end, wherein the first partial-reflector has a first reflectivity; and
a second partial-reflector coupled between the first partial-reflector and the second end, the second partial-reflector being configured to output the second output portion of the amplified light toward the second end and configured to reflect a second reflected portion toward the first partial-reflector, wherein the second partial-reflector has a second reflectivity equal to the first reflectivity.

32.-40. (canceled)

41. The system of claim 1, wherein the fiber laser further comprises a second optical fiber optically coupled to the pump source and including a second-fiber first end, a second-fiber second end, and a second-fiber optical resonator cavity coupled between the second-fiber first end and the second-fiber second end, the second-fiber optical resonator cavity being configured to:
receive at least a portion of the light generated by the pump source;
amplify the light received by the second-fiber optical resonator cavity;
output a second-fiber first output portion of the light received and amplified by the second-fiber optical resonator cavity toward the second-fiber first end as a second-fiber first output beam; and
output a second-fiber second output portion of the light received and amplified by the second-fiber optical resonator cavity toward the second-fiber second end as a second-fiber second output beam.

42. A method of holography, the method comprising:
generating a first laser beam from a first end of an optical fiber of a fiber laser, wherein the optical fiber includes a first portion that extends from an optical resonator cavity of the fiber laser to the first end and wherein the first portion has a first length;
generating a second laser beam from a second end of the optical fiber, the second laser beam being substantially in-phase with the first laser beam, wherein the optical fiber includes a second portion that extends from the optical resonator cavity to the second end and wherein the second portion has a second length equal to the first length;
directing at least a portion of the first laser beam toward a holographic recording medium to generate a reference beam for a holographic image; and
directing at least a portion of the second laser beam toward an object to generate an illumination beam for the holographic image.

43. The method of claim 42, further comprising:
splitting the first laser beam into a first portion and a second portion;
directing the first portion toward the holographic recording medium to generate the reference beam for a holographic image; and
directing the second portion toward the object to generate a second illumination beam for the holographic image.

44. The method of claim 42, further comprising:
splitting the second laser beam into a first portion and a second portion;
directing the first portion toward the holographic recording medium to generate a second reference beam for a holographic image; and
directing the second portion toward the object to generate the illumination beam for the holographic image.

45. The method of claim 42, further comprising configuring at least one of the first laser beam and the second laser beam to generate a reconstruction beam for a holographic image for playback of the holographic image.

46. The method of claim 45, further comprising vibrating at least one of the first end and the second end during playback of the holographic image at an amplitude greater than or equal to a wavelength of the first laser beam and the second laser beam and at an amplitude less than two centimeters.

47.-50. (canceled)

51. The method of claim 42, further comprising:
generating a plurality of first laser beams and a plurality of second laser beams with a plurality of optical fibers; and
generating one or more of the following using the plurality of first laser beams and the plurality of second laser beams: a mural-like holographic image and a wide-angle holographic image.

52.-54. (canceled)
